(19) United States
(12) Patent Application Publication
(10) Pub. No.: US 2014/0184472 A1
(43) Pub. Date: Jul. 3, 2014

(54) DEVICE FOR ELIMINATING DEAD BEZEL OF A DISPLAY SCREEN

(71) Applicants: Zhanmin XIA, Shanghai (CN); Weikang DING, Shanghai (CN)

(72) Inventors: Zhanmin XIA, Shanghai (CN); Weikang DING, Shanghai (CN)

(21) Appl. No.: 14/197,209

(22) Filed: Mar. 4, 2014

Related U.S. Application Data
(63) Continuation-in-part of application No. 13/257,049, filed on Sep. 16, 2011, now abandoned.

(30) Foreign Application Priority Data
Mar. 20, 2009 (CN) 200920069185.6

(51) Int. Cl. G06F 3/14

(52) U.S. Cl. CPC G06F 3/1446
USPC 345/1.3

(57) ABSTRACT

An apparatus for eliminating splicing frames of a display screen includes a first display device, a second display device, and a processing circuit. The first display device, a first display driver coupled to the first display screen, and a frame at an edge of the first display screen for supporting the first display screen. The second display device includes a second display screen covering the frame, and a second display driver coupled to the second display screen. The processing circuit is configured to receive data of the first image, determine pixels to be displayed in the first display device and pixels to be displayed in the second display device, and provide the pixels to the first display device and the second display device.

### RELATED APPLICATION

The application is a continuation-in-part of pending U.S. patent application Ser. No. 13/257,049, titled “A device for Eliminating Splicing Frames of a Display Screen,” filed Sep. 16, 2011, which claims priority and benefits of Chinese Patent Application No. 200920069185.6, filed with State Intellectual Property Office of P. R. China on Mar. 20, 2009. The entire content of above-referenced applications is incorporated herein by reference.

### FIELD

The present disclosure generally relates to display technology. In particular, this invention relates to an apparatus for eliminating the dead bezel of a display screen, which typically consists of frames for structural support and does not display video images. The invention allows seamless expansion of display screen area by replacing the dead bezel with a bezel display which forms an integral display unit with the display screen.

### BACKGROUND ART

Currently, it is difficult to have a one-piece Liquid Crystal Display (LCD) or Plasma Display Panel (PDP) which extends over 80 inches in size. One reason is because the latest manufacturing technology of LCD panels and PDPs does not provide for a reliable way of producing large display panels. Another reason is that large display panels are difficult to transport. Therefore, a large-size LCD/PDP display screen, which extends over 80 inches in size are normally not produced in commercial scale. While digital projection can be used for large-size display, digital projection is restricted by projection space, display brightness and uniformity of the brightness, while requiring high brightness light sources, which have much shorter life span than an LCD.

Although LEDs (light-emitting diodes) are sometimes used for larger display panels, LED display panels have low resolution compared with LCD/PDP displays. The pitch of an LED is usually between 10 mm to 4 mm, which is referred to as P10˜P4; compared with 0.6 mm pitch of an LCD and 1.0 mm pitch of a PDP, the display effect of LED is not satisfactory. Currently, the minimum pitch adopted for LED displays is about 2 mm, by which the display effect has been improved to achieve such pitch, however, 250,000 pieces of RGB LED will be provided per square meter, which leads to heavy power consumption and severe heat generation. For these reasons, LED display panels are also not suitable for viewing from a short distance and/or for a long duration. But there are needs for large display panels suitable for viewing from a short distance and/or for a long duration, such as displays used in airport terminals, billboards, etc.

Because of the short-coming of LED display panels and the difficulty of producing a single large-size LCD/PDP display panel, it is common to expand smaller-size LCD/PDP screens in array to form a larger “video wall.” But because LCD/PDP screens are surrounded by bezels which provide structural support, wiring support, and back-lighting (for LCDs), and those bezels typically do not display anything (therefore they are also commonly known as “dead bezels”), the screen array with dead bezel combination results in the appearance of a “grid,” which displays no video over the video wall. Such a grid not only affects the appearance of the display but also introduces distortion, and/or loss of image information, as the displayed image is split between the screens separated by the grid.

FIGS. 1A to 1E illustrate the distortion and/or loss of information introduced by existing technology when splitting an image among the display screens while accommodating the dead bezel. As shown in FIG. 1A, an image 100 has a white cross 102 in the middle and indentations 101a, 101b, 101c, and 101d at its circumference.

FIG. 1B shows one method of splitting image 100 among four display screens with the current technology. In order to accommodate a dead bezel 111, areas 113 and 114 are discarded, leaving behind areas 115a, 115b, 115c and 115d to be displayed. Area 115a is to be displayed in a display screen 112. FIG. 1D illustrates the display of image 110 following the splitting method of FIG. 1B. Display system 130 includes display screens 132a, 132b, 132c, and 132d, each of which respectively is surrounded by dead bezels 131a, 131b, 131c, and 131d, and each of which respectively displays areas 115a, 115b, 115c, and 115d of FIG. 1B. Although the combined image shows no distortion, part of image 100, such as the white cross 102 and indentations 101a, 101b, 101c, and 101d, are not displayed.

FIG. 1C shows another method of splitting image 100 among four display screens with the current technology, where none of image 100 is discarded. Image 100 is split along the lines 123 and 124 into portions 125a, 125b, 125c, and 125d. FIG. 1E illustrates the display of image 110 following the splitting method of FIG. 1E. Display system 134 includes display screens 142a, 142b, 142c, and 142d, each of which respectively is surrounded by dead bezels 141a, 141b, 141c, and 141d, and each of which respectively displays portions 125a, 125b, 125c, and 125d of FIG. 1C. While the white cross 102 and indentations 101a, 101b, 101c, and 101d are displayed, each portion is “squeezed” to accommodate the aspect ratio (typically 16:9) of the display screen. Given that the dead bezels introduce substantial discontinuities between the squeezed images, a viewer who views the squeezed images together with the dead bezels will perceive considerable distortion.

The aforementioned phenomena are further illustrated in FIGS. 2A and 2B. In FIG. 2A, where the image is split following the method illustrated in FIG. 1B, portions of the images are discarded to accommodate the dead bezels, for example, the eyes. In FIG. 2B, where the image is split following the method illustrated in FIG. 1C, the combined image viewed together with the dead bezels, shows considerable distortion. While the aforementioned problems can be alleviated by using special PDP screens with narrow bezel, such special PDP screens are expensive and have short life span. Also, even if the bezel is narrow, it will still introduce discontinuity and distortion.

Therefore, there is a need to provide a bezel display which forms an integral display unit with one or more display screens, such that a large seamless display unit can be provided without introducing distortion or loss of information.

### SUMMARY OF THE DISCLOSURE

Additional aspects and advantages of embodiments of present disclosure will be given in part in the following descriptions, become apparent in part from the following descriptions, or be learned from the practice of the embodiments of the present disclosure.

According to some embodiments, an apparatus for eliminating splicing frames of a display screen includes a first display device, a second display device, and a processing circuit. The first display device includes a first display screen including a liquid crystal display (LCD) or plasma display panel (PDP) to display a first portion of a first image, a first display driver coupled to the first display screen, and a frame at an edge of the first display screen for supporting the first display screen. The second display device includes a second display screen covering the frame, wherein the second display screen includes a light-emitting diode (LED) display or organic light-emitting diode (OLED) display to display a second portion of the first image, and a second display driver coupled to the second display screen. The processing circuit is configured to receive data of the first image, determine pixels to be displayed in the first display device and pixels to be displayed in the second display device, and provide the pixels to be displayed in the first display device to the first display driver for displaying on the first display device, and the pixels to be displayed in the second display device to the second display driver for displaying on the second display device. The first portion displayed in the first display device and the second portion displayed in the second display device form an integral image consistent with the first image.

According to some embodiments, the second display screen immediately borders the first display screen. The processing circuit comprises a field-programmable gate array (FPGA) circuit. The processing circuit may be further configured to store the pixels to be displayed in the first display device and the pixels to be displayed in the second display device in the memory and provide the pixels to be displayed in the first display device in the memory to the first display device and the pixels to be displayed in the second display device in the memory to the second display device at substantially the same time.

### BRIEF DESCRIPTION OF THE DRAWINGS

These and other aspects and advantages of embodiments of the present disclosure will become apparent and more readily appreciated from the following descriptions made with reference the accompanying drawings, in which:

FIGS. 1A-1E illustrate prior art implementations of combining screens with dead bezels to expand display area;

FIGS. 2A-2B illustrate the effect of loss of image data and distortion of displayed images due to prior art's implementations;

FIG. 3 illustrates an exemplary method of splitting an image among display screens while avoiding loss of image data and distortion of the displayed image, according to one embodiment of the present disclosure;

FIG. 4A-B illustrate exemplary methods of splitting an image and scaling portions of the split image, according to one embodiment of the present disclosure;

FIG. 5 is a flow diagram illustrating an exemplary method of splitting an image among display screens, and then scaling each split image, while avoiding loss of image data and distortion of displayed image, according to one embodiment of the present disclosure;

FIG. 6 illustrates an exemplary display system which receives image data, generates and transmits portions of data to be displayed on a bezel display and portions of data to be displayed on a display screen, according to one embodiment of the present disclosure;

FIG. 7 illustrates an exemplary video processing system disclosed in FIG. 6, according to one embodiment of the present disclosure;

FIG. 8 illustrates an exemplary processor subsystem of the video processing system disclosed in FIG. 6, according to one embodiment of the present disclosure; and

FIG. 9 illustrates an exemplary display system, which includes a display unit combining an LCD display screen and an LED bezel display, according to one embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions. In this regard, directional terminology, such as directional terminology, such as “top,” “bottom,” “front,” “back,” “leading,” “trailing,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes, including changes in the order of process steps, may be made without departing from the scope of the present invention. The following detailed description, therefore, is not to be taken in a limiting sense, and the scope of the present invention is defined by the appended claims.

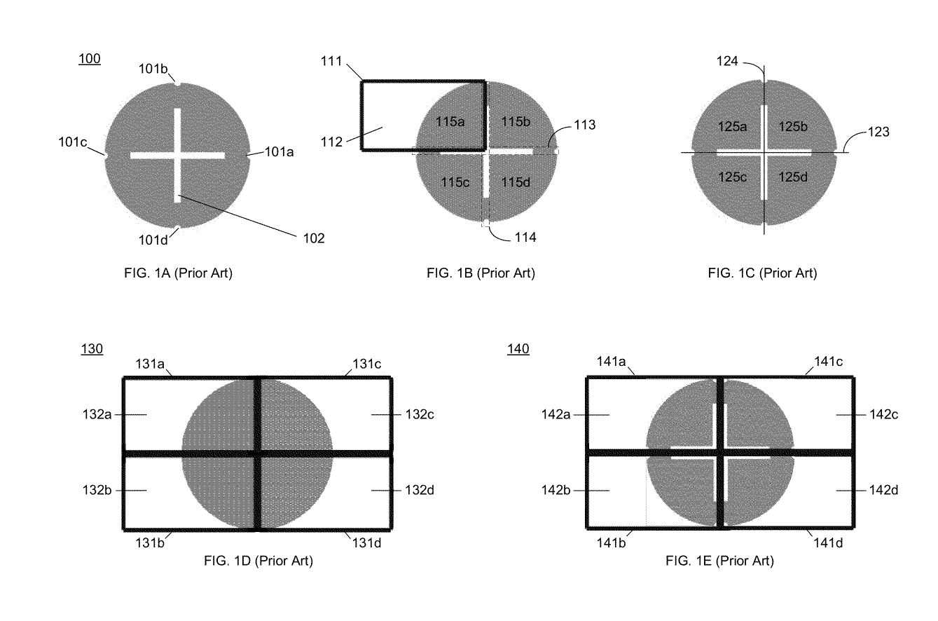

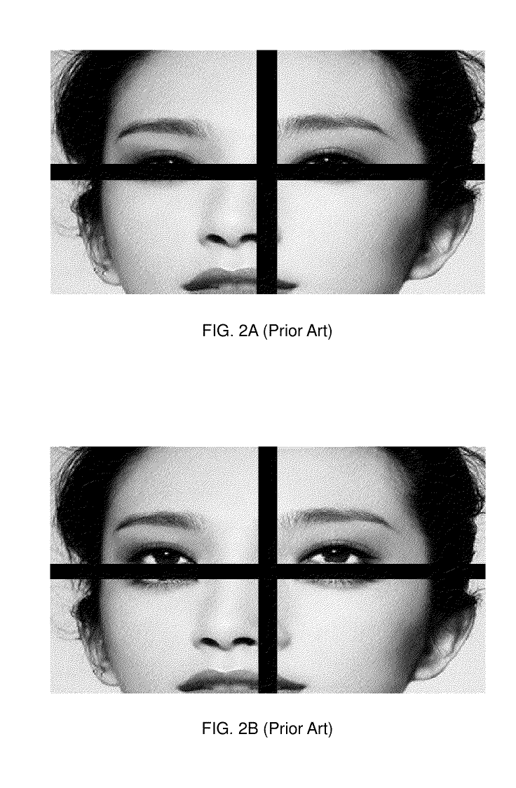

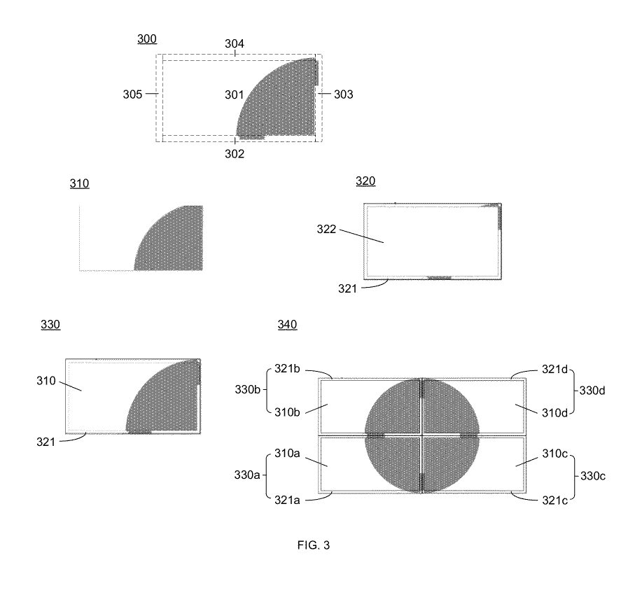

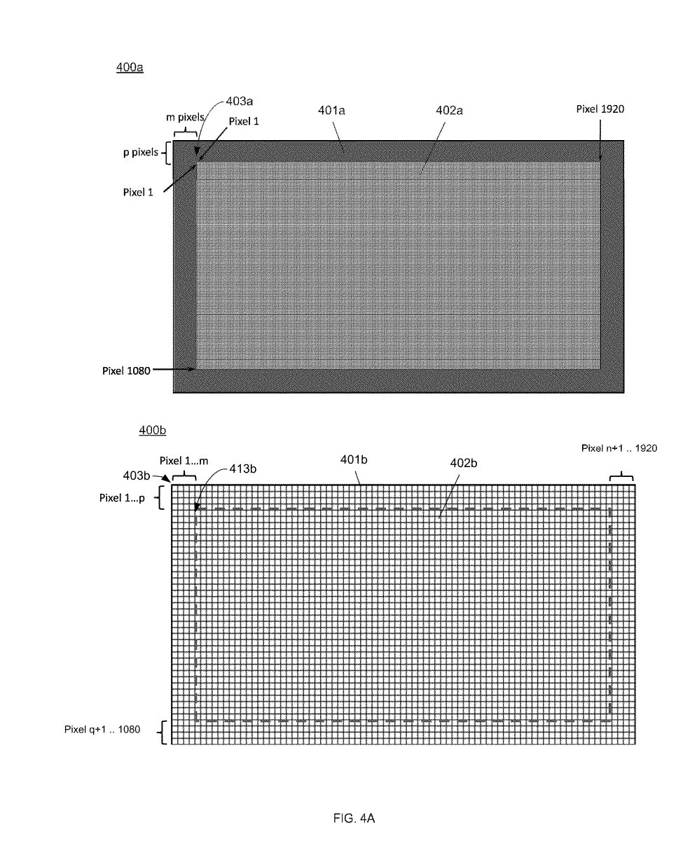

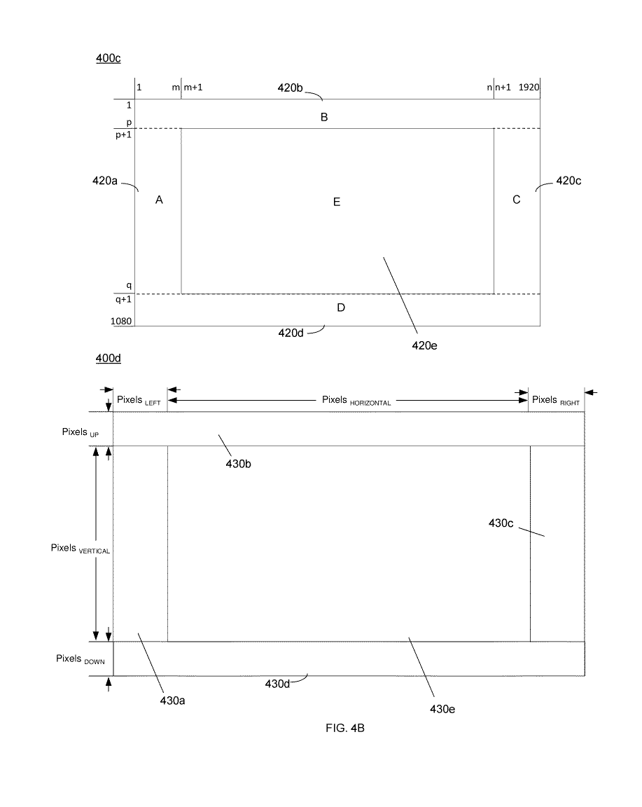

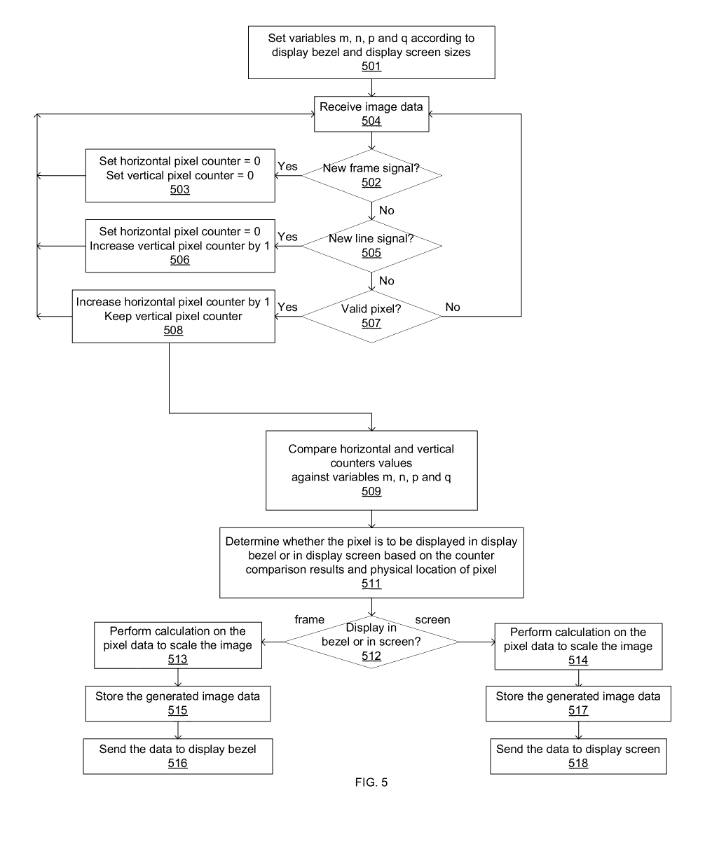

FIG. 3 illustrates a method of splitting an image among display screens while avoiding loss of image data and distortion of displayed image, according to one embodiment of the present disclosure. As shown in FIG. 3, an image 300, which constitutes a quarter of image 100 of FIG. 1A, can be split into portions 301, 302, 303, 304, and 305. Portion 301 can be displayed in a display screen 310, while portions 302, 303, 304, and 305 can be displayed in a bezel display 321 of a display system 320. Bezel display 321 surrounds an empty space 322, into which display screen 310 can be fitted. With display screen 310 fitted into bezel display 321 to form an integral display unit 330, a combined image which is consistent with image 330 can be displayed. Also, each of portions 301, 302, 303, 304, and 305, when displayed, can be scaled with the same ratio to avoid distortion. When a plurality of integral display units 330 are combined together to form a display system 340, the combined image is an integral image, same as the original image, except for the scaling, and the combined image displays no distortion. Since the bezel displays 321a-d can be used to display part of the image, no information is lost. For example, the white cross 102 and indentations 101a-d of image 101 in FIG. 1A are displayed in bezel displays 321a-d.

FIG. 4A illustrates a method of splitting an image and scaling the split portions of the image, according to one embodiment of the present disclosure. A person with ordinary skill in the art will understand that since a display device typically receives image data sequentially, pixel by pixel, the “splitting” of an image is typically implemented by determining the display location of each pixel in the image in each of the display devices combined to display the image.

A display unit 400a includes a display screen 402a surrounded by a frame, which can be called dead bezel 401a. The dead bezel has a vertical thickness of p pixels and a lateral thickness of m pixels. Display screen 402a may have a standard size for a high definition monitor or TV (e.g. 1920 pixels×1080 pixels), with a reference origin 403a (indicated by horizontal and vertical pixel 1). As display system 400a receives image data, which may contain information of color of one or more pixels, display system 400a calculates the display location of each pixel with reference to reference origin 403a and based on the length and width of screen 402a. Each pixel can then be displayed on screen 402a.

According to an embodiment of the present disclosure, a display unit 400b includes a display screen 402b surrounded by a bezel display 401b. The combined system has a reference origin 403b. Display screen 402b also has a reference origin 413b. When image data is provided to display unit 400b, the display location of each pixel within display unit 400b, relative to reference origin 403b, can be used to determine whether a pixel is to be displayed in bezel display 401b or in display screen 402b. For example, the co-ordinates of the pixel can be compared with the known physical pixel locations for bezel display 401b (e.g. a horizontal pixel co-ordinate within the range of [l, m] or [n, 1920], and a vertical pixel co-ordinate within the range [1, p] or [q, 1080]) and, upon determining that the pixel is to be displayed in the peripheral area of display unit 400b, the pixel can be sent to bezel display 401b. On the other hand, if a pixel is determined to be displayed in the display screen in the middle of display unit 400b, the pixel can be sent to display screen 402b.

In some embodiments, the bezel display may comprise a plurality of display screens, each of which has its own reference origin different from reference origin 403b. In some embodiments, the display location of a pixel in bezel display 401b and/or in display screen 402b and the scaling ratio can be determined based on factors including dimensions of the frame (dead bezel), such the length and width of the dead bezel, dimensions of the display screen 402b, such as the length and width of the display screen 402b, dimensions of the combined display unit 400b, such as the length and width of the combined display unit, the resolution settings of the display screen 402b, etc. In some embodiments, the display location of a pixel in bezel display 401b and/or in display screen 402b and the scaling ratio can be determined based on factors including dimensions of the bezel display 401b, such the length and width of the bezel display, dimensions of the display screen 402b, such as the length and width of the display screen 402b, dimensions of the combined display unit 400b, such as the length and width of the combined display unit, the resolution settings of the bezel display 401b and display screen 402b, etc. In some embodiments, the bezel display 401b immediately borders display screen 402b as shown in FIG. 4A. In some embodiments, the bezel display 401b has the same dimensions as the frame of display screen 402a, as shown in FIG. 4A. In some embodiments, the resolution the bezel display 401b and display screen 402b are set to the same.

As an example, when a display unit 400b with a size of 1920 pixels×1080 pixels is used to display an image with a size of 720 pixels×480 pixels, the image can be scaled up to fulfill the screen size 1920 pixels×1080 pixels based on the ratio between the new size (1920 pixels×1080 pixels) and the original size (720 pixels×480 pixels). In some embodiments, the scaling of display location of the pixel can be based on the physical location of the reference origin 413b relative to reference origin 403b. By scaling the display locations of pixels in both bezel display 401b and display screen 402b with the same ratio, bezel display 401b and display screen 402b can form an integral display unit.

In some embodiments, the display location for each pixel to be displayed in bezel display 401b and display screen 402b is determined in real-time. In some embodiments, the transmissions of pixels to the bezel display and to the display screen are synchronized so that the renderings of both bezel display and display screen occur at the same time. For example, separate frame buffers can be used to store the pixel data for bezel display 401b and display screen 402b. When a frame of image data is processed, the portion to be displayed on bezel display 401b is stored in one buffer, and portion to be displayed on the display screen 402b is stored in one buffer. The buffers are controlled, e.g., by a processing circuit, to release the pixel data to the driver(s) for bezel display 401b and to the driver(s) for display screen 402b separately and simultaneously, and each buffer may contain enough pixels data to, when combined together, render at least one frame. Synchronization can be achieved when each buffer is controlled to accumulate the pixel data, without sending to its corresponding display driver(s), until there are enough data to at least render one frame, upon which time each frame buffer can then be allowed to release the data to its corresponding display driver(s). As result, bezel display 401b and display screen 402b can receive the pixel data in real-time (e.g. at substantially the same time) and can form an integral display unit for a series of images (e.g., a video). The images displayed on bezel display 401b and display 402b for an integral image, which is the same as the original image. In some embodiments, a micro-controller can be used to process the data, store it in the buffers, and control the buffers to perform the aforementioned synchronization scheme.

FIG. 4B illustrates a method of splitting a source image and then scaling the split portions of the source image, according to some embodiments of the present disclosure. A source image 400c of a size of, for example, 1920 pixels×1080 pixels, is to be displayed in a display unit 400d. In some embodiments, image 400c can be split into a central portion (e.g. 420e) and a surrounding portion (areas covering portions 420a, 420b, 420c, and 420d). The display unit 400d includes a display screen 430e and a bezel display which includes display areas 430a, 430b, 430c and 430d. In some embodiments, the bezel display includes a plurality of display screens. In some embodiments, the bezel display includes four display screens, each screen covering one of the display areas 430a, 430b, 430c and 430d.

The bezel display has a vertical thickness of Pixel_{UP} on the top, and a vertical thickness of Pixel_{DOWN} in the bottom, both in terms of pixels. The bezel display also has a horizontal thickness of Pixel_{LEFT} on the left, and a horizontal thickness of Pixel_{RIGHT} on the right, both in terms of pixels. Display area 430a has a length of Pixel_{LEFT} and a height of Pixel_{VERTICAL}. Display area 430b has a length of (Pixel_{LEFT}+P_{HORIZONTAL}+Pixel_{RIGHT}) and a height of Pixel_{UP}. Display screen area 430c has a length of Pixel_{RIGHT} and a height of Pixel_{VERTICAL}. Display screen area 430d has a length of (Pixel_{LEFT}+P_{HORIZONTAL}+Pixel_{RIGHT}) and a height of Pixel_{DOWN}. A person having ordinary skill in the art should understand that the bezel displays can have various dimensions, and the display areas can be designed differently from the one shown in FIG. 4B.

In some embodiments, before image 400c is displayed on display unit 400d, image 400c can be “split” into image portions 420a, 420b, 420c, 420d, and 420e, wherein “splitting” includes determining which part is to be displayed in the display screen 430e, and which part is to be displayed in the bezel display, in other words, determining whether a pixel is part of image portions 420a, 420b, 420c, 420d or 420e. Image portion 420a has a length of m pixels and a height of (q−p) pixels. Image portion 420b has a length of 1920 pixels and a height of p pixels. Image portion 420c has a length of (1920−n) pixels and a height of (q−p) pixels. Image portion 420d has a length of 1920 pixels and a height of (1080−q) pixels. Image portion 420e has a length of (n−m) pixels and a height of (q−p) pixels. In some embodiments, image portion 420e can be displayed in display screen 430e, while image portion 420a can be displayed in display area 430a of the bezel display, image portion 420b can be displayed in display area 430b, image portion 420c can be displayed in display area 430c, and image portion 420d can be displayed in display area 430d.

In some embodiments, each portion of image 400c can be scaled before being displayed in display unit 400d. The scale ratio for each portion of image 400c may be the same. The addresses, such as, X and Y coordinates of the display location of a pixel in each portion of image 420c can be converted to new addresses in either display screen 430e or in one of display areas 420a-d.

The display area of display screen 430e plus bezel display 430a-430d is larger than the screen that image 400c was originally to be displayed. The original source image 400c is to be scaled to fill fully the display area of display screen 430e and bezel display 430a-430d. The scaling may be as follows:
For the center portion 420e of input source image 400c is (n−m)×(q−p) to be scaled to P_{HORIZONTAL}×P_{VERTICAL} to fulfill display screen (which can be the screen that the original image was intended to be displayed. If that is the case, the center portion can be scaled to 1920×1080);
For the portions 420a-420d of input source image are:
1) UP: scaled from 1920×p to (P_{LEFT}+P_{HORIZONTAL}+P_{RIGHT})×P_{UP}
2) DOWN: scaled from 1920×(1080−q) to (P_{LEFT}+P_{HORIZONTAL}+P_{RIGHT})×P_{DOWN}
3) LEFT: scaled from m×(q−p) to P_{VERTICAL}×P_{LEFT}
4) RIGHT: scaled from (1920−n)×(q−p) to P_{VERTICAL}×P_{RIGHT}.

The four points m, n, p, and q can be determined by the dimension (e.g., area, length, or width) ratio of the combined display (including the center display area 430e and the bezel display areas 430a-430d) to the original display area (which the source image was to be displayed). The original display area can be the center display area 430e. The bezel displays cover the frames on the four edges of the original display area. By scaling, the input source image 400c, which was originally intended to be displayed in the center area 430e (e.g., a display area of a LCD display), now fulfills the combined area (including the center display area 430e and the bezel display areas 430a-430d). The central area 420e defined by m, n, p, and q now fulfills the central area 430e, and the side portions are displayed on the bezel displays.

In process, according to some embodiments, the processing circuit first obtains the scaling ratio based on the dimensions of the original display and the bezel displays. The processing circuit then determines points m, n, p, and q. Next, for each pixel, the processing circuit determines its location. For example, if a pixel is in the area 420e, the processing circuit determines it will be displayed in area 430e. The processing circuit will convert its original addresses to new addresses for displaying in area 430e. If a pixel is in the area 420a, the processing circuit determines it will be displayed in area 430a. The processing circuit will convert its original addresses to new addresses for displaying in area 430a. The image will be scaled accordingly. The processing circuit can use existing technologies, for example, technologies for adjusting images to fit different size screens, to covert the addresses and scale the image.

FIG. 5 is a flow diagram illustrating a method of splitting an image among display screens, and then scaling each split image, while avoiding loss of image data and distortion of displayed image, according to one embodiment of the present disclosure. Referring to FIGS. 4A and 4B, a horizontal pixel co-ordinate within the range of [1, m] or [n, 1920], and a vertical pixel co-ordinate within the range [1, p] or [q, 1080], indicate that the pixel is in bezel display 401b. In step 501, the values of m, n, p and q are set, according to the sizes (dimensions) of bezel display 401b and display screen 402b. In step 504, image data, which may include pixel address and color information, is received. Image data can also include other signals, such as new frame signal or new line signal. After step 504, step 502 can be executed to determine whether the data includes a new frame signal (e.g., a new frame of image). If that is the case, both the horizontal and vertical pixel counters can be set to zero, in step 503. If the data do not include a new frame signal, step 505 can be executed to determine whether the data include a new line signal. If that is the case, the horizontal pixel counter can be set to zero, while the vertical pixel counter can be incremented by 1, in step 506. If the data contains neither a new frame signal nor a new line signal, step 507 can be executed to determine whether the data include valid pixel information. If that is the case, the horizontal pixel counter can be incremented by 1, while the vertical pixel counter value can be maintained, in step 508. After steps 503, 506, and 508, as shown by the arrows to the left, the processing circuit receives new image data, as shown in step 504, and for example, store it in a memory. If the data contains no new frame signal, no new line signal, and no valid pixel information, the data can be discarded and step 504 can be executed again to receive the next image data.

If the pixel is valid, in step 509, the horizontal and vertical pixel counters values can then be compared against variables m, n, p, and q. In step 511, based on the comparison results, the processing circuit determines the new location of the pixel, including, for example, whether the pixel is to be displayed in bezel display 401b or in display screen 402b. Upon determining that the pixel is for bezel display 401b, in step 513, the processing circuit performs calculation on the pixel data to scale the image. In step 515, the processing circuit stores the generated image data from step 513 in a location of a memory specifically for the bezel display (e.g. a second frame buffer). On the other hand, upon determining that the pixel is for display screen 402b, in step 514, the processing circuit performs calculation on the pixel data to scale the image. In step 517, the processing circuit stores the generated image data from step 514 in a location of a memory specifically for the display screen (e.g. a first frame buffer). When a frame of image data is processed, and it is ready to be displayed, the processing circuit can execute steps 516 and 518, for example, at the same time, to send the image data to the display screen and the bezel display. Although the description of FIG. 5 is with reference to FIG. 4A, the method of FIG. 5 can be used to generate display location of pixel data for other embodiments according to this disclosure.

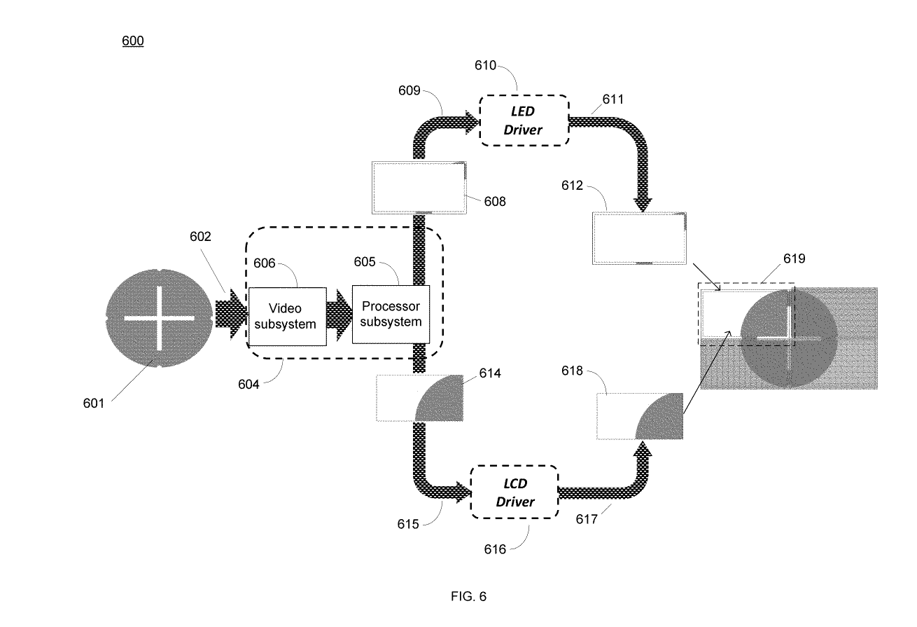

FIG. 6 illustrates a display system which receives image data, generates and transmits portions of data to be displayed on a bezel display and portions of data to be displayed on a display screen, according to one embodiment of the prevent disclosure. Display system 600 includes a video processing system 604, one or more LED drivers 610, one or more LCD drivers 616, one or more LED bezel displays 612, and one or more LCD display screens 618. Although FIG. 6 shows that a LCD display screen 618 and a LED bezel display 612 are used, other configurations can also be used. For example, display system 600 may use a LCD or PDP display screen with an LED or OLED bezel display. Display system 600 may also use the same or different display devices (e.g., LCD, PDP, LED or OLED) for the display screen and the bezel display. As an example, the application describes an LCD display as a display screen, and an LED display as a bezel display. A person having ordinary skill in the art should appreciate that other combinations can also be used. In some other embodiments, each edge of an LCD screen may correspond to an LED bezel display, and that LED bezel display may be controlled by one LED driver. In some other embodiments, an LED driver may control a few bezel displays.

Video processing system 604 includes a video subsystem 606 and a processor subsystem 605. Video processing system 604 can receive image data 601 through data bus 602. Video processing system 604 can then process the image data, determine whether a pixel is to be displayed in bezel display 612 or in display screen 618 and generate the display location for the pixel either in bezel 612 or in screen 618 and calculate the pixel data to scale the image accordingly. System 604 can send pixel information (e.g., color and display location) for bezel display (data represented by 608) to LED driver 610 through a data bus 609, and/or pixel information (e.g., color and display location) for display screen (data represented by 614) to LCD driver 616 through a data bus 615. LED driver 610 and LCD driver 616 can then send the pixel data to, respectively, LED bezel display 612 and LCD display screen 618 through data buses 611 and 617, allowing the bezel display and the screen to display an integral image 619. In some embodiments, LED driver 610 and LCD driver 616 can be controlled such that bezel display 612 and display screen 618 can receive their pixel data at substantially the same time. For example, video processing system 604 can receive and process pixel data for a frame of image, store them separately for the bezel display and for the display screen, and then send out the data, allowing the bezel display and the display screen to be updated at the same time, thereby forming an integral display unit for a series of images (e.g. a video).

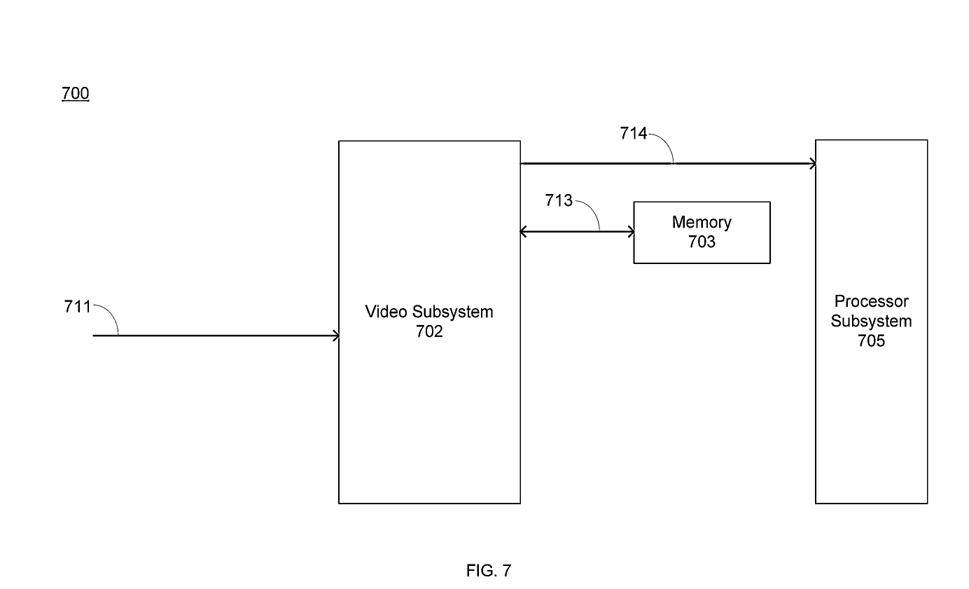

FIG. 7 illustrates a video processing system according to one embodiment of the present disclosure. Video processing system 700 includes a video subsystem 702 and a processor subsystem 705. In some embodiments, video processing system 700 can be used as the video processing system 604 in FIG. 6 to receive image data and provide pixel data and display location for bezel display 612 and display screen 618. Video subsystem 702 can be a video board or video card, such as ones used in TV or computer systems. In some embodiments, the functionalities of video subsystem 702 can be implemented with a video controller board, a display expansion board, etc. Video subsystem 702 can be configured to take in video data (e.g. a series of image data) in various data format, such as High-Definition Multimedia Interface (HDMI), Digital Visual Interface (DVI), Videos Graphics Array (VGA), Component video, etc., through interface 711, and to convert the video data into one or more signaling formats for downstream LCD and LED drivers. In some embodiments, subsystem 702 can be configured to convert the video data into a signaling format substantially conformed to the standard of low voltage differential signaling (LVDS). Video subsystem 702 may also interface with memory 703 through interface 713, wherein memory 703 provides storage for data and instructions relevant to the processing of the video data. Video subsystem 702 is configured to transmit the converted video data to a processor subsystem 705 through interface 714 for further processing, wherein subsystem 705 can be configured, for example, to implement the method disclosed in FIG. 5 to determine whether a pixel is to be displayed in the bezel display or in the display screen, and to generate display location for the pixel in either the frame or in the screen. In some embodiments, video subsystem 702 is configured to transmit video data in the format of LVDS to processor subsystem 705.

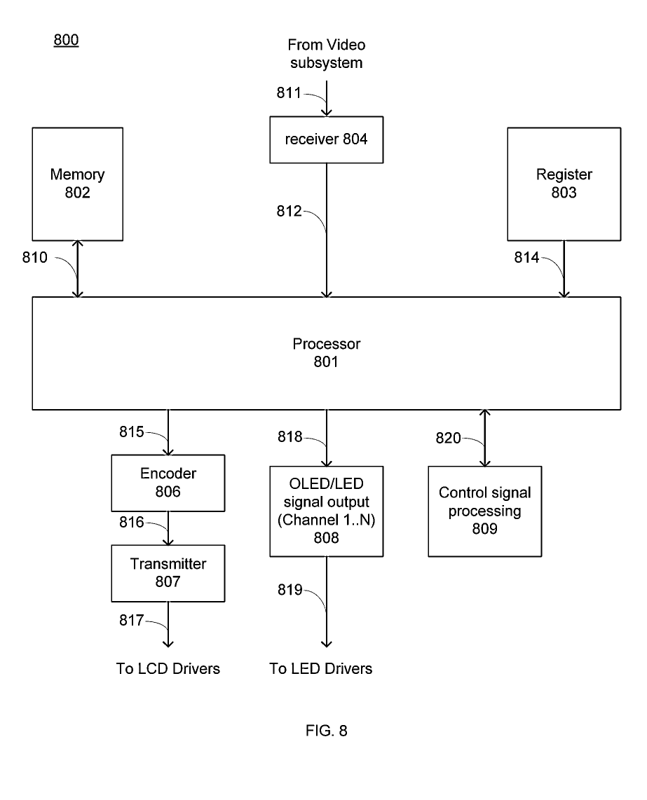

FIG. 8 illustrates an exemplary processor subsystem according to one embodiment of the present disclosure. Processor subsystem 800 includes a processor 801, a memory 802, a receiver module 804, a decoder module 805, an encoder module 806, a transmitter module 807, and a LED/OLED signal output module 808. In some embodiments, processor subsystem 800 can be used as the processor subsystems 705 and 605 respectively in FIG. 7 and in FIG. 6, to receive converted video data from a video subsystem (e.g. subsystem 606 in FIG. 6 or subsystem 702 in FIG. 7) through an interface 811 and to generate pixel data and display locations for downstream LCD and LED drivers. In some embodiments, processor subsystem 800 receives the video data through receiver 804, which can be a circuit capable of receiving a signal conforming to formats such as LVDS with low voltage swing, and converting the signal to a digital format (e.g. a signal with high voltage swing). In some embodiments, receiver 804 further includes a decoder to decode the signal. For example, receiver 804 may receive a LVDS signal encoded with 8b/10b encoding, and receiver 804 can include a LVDS decoder to decode the LVDS signal so that pixel information can be readily obtained. Receiver 804 can then transmit the converted video data to processor 801 through a data bus 812.

In some embodiments, processor 801 is configured, for example, to implement the method disclosed in FIG. 5 to determine whether a pixel is to be displayed in the bezel display or in the display screen, and to generate display location for the pixel in either the bezel display or in the display screen. In some embodiments, processor 801 includes a field-programmable gate array (FPGA) circuit which can be programmed with a hardware descriptive language, such as Verilog, to implement the method disclosed in FIG. 5. In some embodiments, processor 801 includes a microcontroller unit (MCU) or a general purpose central processing unit (CPU) which can be programmed with a software language, such as C++, to implement the method disclosed in FIG. 5. In some embodiments, processor 801 includes an application-specific integrated circuit (ASIC) constructed to implement the method disclosed in FIG. 5. In some embodiments, processor subsystem 800 further includes a register 803, which stores configuration information for processor 801 and which processor 801 can access through an interface 814. In some embodiments, processor subsystem 800 further includes a control signal processing module 809, which can receive various control signals for the LCD and LED displays such as color and contrast from an external source (not shown in FIG. 8), process the control signals and provide the information to processor 801 through an interface 820. Processor 801 can then adjust the pixel color according to the information.

Processor 801 also interfaces with memory 802 through interface 810. In some embodiments, memory 802 provides the storage for software instructions to implement the method disclosed in FIG. 5. In some embodiments, memory 802 provides storage for pixel data received or processed by processor 801. For example, pixel data to be provided for bezel display and for screen can be stored in separate locations inside memory 802.

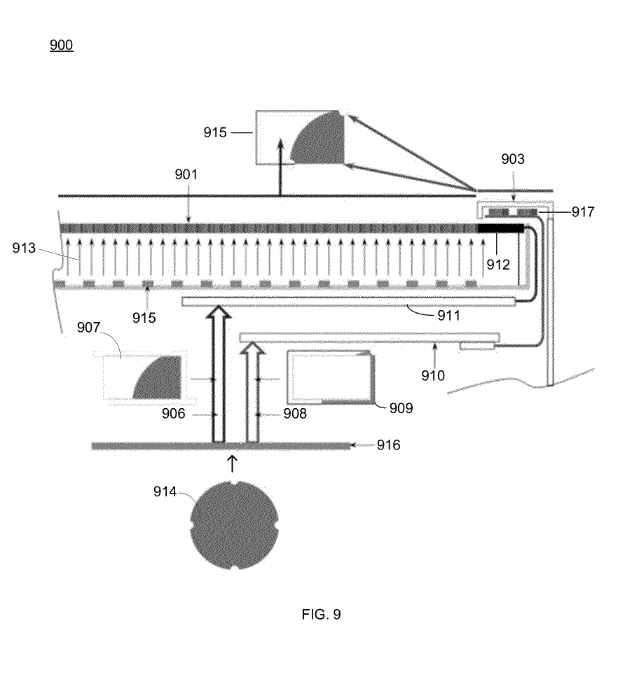

After processor 801 generates a pixel data (e.g. color and display location) and determines that the data is to be sent to an LCD driver (e.g. if the data is for a LCD display screen), the pixel data, which can be in digital format, can be sent to encoder 806 through an interface 815. Encoder 806 can then encode the data with, for example, 8b/10b encoding. The encoded data can then be sent to transmitter 807 through an interface 816, which converts the encoded data to LVDS or other signaling format for the downstream LCD drivers, and transmits the converted data to LCD drivers through an interface 817. If processor 801 determines that a pixel data is to be sent to a LED driver (e.g. if the data is for a LED bezel display), the pixel data can be sent to a LED signal output module 808, through an interface 818. Module 808 can then convert the pixel data from a digital format to a signaling format for downstream LED drivers, and transmits the converted data to LED drivers through an interface 819. In some embodiments, an OLED bezel display can be used, and the module 808 can be used to convert the pixel data from a digital format to a signaling format for downstream OLED drivers. In some embodiments, LED/OLED signal output module 808 can have multiple channels (e.g. N channels as shown in FIG. 9) to drive multiple display panels in the LED/OLED bezel display. This allows different display panels of the bezel display to be updated in real-time (e.g. at substantially the same time), which allows a high refresh rate. In some embodiments, processor 801 can store the processed pixel data in memory 802. The data to be displayed in the LED bezel display and in the LCD display screen are stored in the memory. The processor 801 can retrieve and send data to be displayed in the LED bezel display and in the LCD display screen at the same time, so that the LCD display screen and the LED/OLED bezel display receive the data at the same time, which allows the display screen and the bezel display to form an integral image.

FIG. 9 illustrates an exemplary display system which includes a display unit combining a LCD screen and a LED bezel display, according to one embodiment of the present disclosure. Display system 900 includes a video processing system 916, an LED driver 910, an LCD driver 911, and a display unit which includes an LCD screen 901, an LED (or OLED) bezel display 917, and a support, for example, a transparent holder 903. The display unit also includes a backplane 915 and a splice frame 912, which can provide structural support to the display unit. Backplane 915 contains light emitting elements (e.g. light bulbs) which shine light (indicated by 913) and act as light sources for LCD screen 901. In some embodiments, the light sources can be installed in splice frame 912. Spice frame 912 can be covered with LED bezel display 917 such that spice frame 912 is not visible as a “dead bezel” for a viewer standing in front of the display unit. Bezel display 917 can then be further covered by transparent holder 903 which can provide structural support to the bezel display. In some embodiments, holder 903 can be made of a material which is not only transparent but also provides special effects, such as diffusion, to smoothen the image displayed. The LED bezel display 917 can receive pixel data from LED driver 910, while the LCD display screen 901 can receive pixel data from LCD driver 911. LED driver 910 receives pixel data 908 for an image portion 909 from video processing system 916. LCD driver 911 also receives pixel data 906 for an image portion 907 from video processing system 916. Video processing system 916 can be implemented to have substantially the same functionality of video processing system 604 in FIG. 6, to receive image data 914 and to provide pixel information (e.g. color and display location) to LCD driver 911 and LED driver 910. With such an implementation, LCD screen 901 and LED bezel display 917 can form an integral display unit to display a combined image of 915.

Reference throughout this specification to “an embodiment,” “some embodiments,” “one embodiment”, “another example,” “an example,” “a specific examples,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example, “in an example,” “in a specific examples,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. An apparatus for eliminating splicing frames of a display screen, comprising:
a first display device comprising:
a first display screen including a liquid crystal display (LCD) or plasma display panel (PDP) to display a first portion of a first image;
a first display driver coupled to the first display screen; and
a frame at an edge of the first display screen for supporting the first display screen;
a second display device including:
a second display screen covering the frame, wherein the second display screen includes a light-emitting diode (LED) display or organic light-emitting diode (OLED) display to display a second portion of the first image; and
a second display driver coupled to the second display screen; and
a processing circuit configured to:
receive data of the first image;
determine pixels to be displayed in the first display device and pixels to be displayed in the second display device; and
provide the pixels to be displayed in the first display device to the first display driver for displaying on the first display device, and the pixels to be displayed in the second display device to the second display driver for displaying on the second display device, wherein the first portion displayed in the first display device and the second portion displayed in the second display device form an integral image consistent with the first image.

2. The apparatus of claim 1, wherein the second display screen immediately borders the first display screen.

3. The apparatus of claim 1, wherein the processing circuit comprises a field-programmable gate array (FPGA) circuit.

4. The apparatus of claim 1 further comprising a memory, wherein the processing circuit is further configured to:
store the pixels to be displayed in the first display device and the pixels to be displayed in the second display device in the memory;
provide the pixels to be displayed in the first display device in the memory to the first display device and the pixels to be displayed in the second display device in the memory to the second display device at substantially the same time.

5. The apparatus of claim 1, wherein the second display driver comprises an LED or OLED drive circuit.

6. The apparatus of claim 1, wherein the frame comprises four frames at four edges of the first display screen, and the second display device includes four second display screens covering the frames, each second display screen is driven separately by a second display driver.

7. The apparatus of claim 1, wherein the processing circuit is configured to determine pixels to be displayed in the first display device and pixels to be displayed in the second display device based on the dimensions of the frame and the dimensions of the first display screen.

8. The apparatus of claim 1, wherein the processing circuit is configured to determine pixels to be displayed in the first display device and pixels to be displayed in the second display device based on the dimensions of the frame, the dimensions of the first display screen, and the resolution of the first display screen.

9. The apparatus of claim 1, wherein the processing circuit is configured to determine pixels to be displayed in the first display device and pixels to be displayed in the second display device based on the dimensions of the first display screen and the dimensions of the second display screen.

10. The apparatus of claim 1, wherein the processing circuit is configured to determine pixels to be displayed in the first display device and pixels to be displayed in the second display device based on the dimensions of the first display screen, the dimensions of the second display screen, the resolution of the first display screen, and the resolution of the second display screen.

11. The apparatus of claim 1, wherein the processing circuit is configured to set the resolution of the first display screen and the second display screen to be the same.

12. The apparatus of claim 1, wherein the second display screen has the same dimensions as the frame.
